(19) United States
(12) Patent Application Publication
(10) Pub. No.: US 2010/0127984 A1
(43) Pub. Date: May 27, 2010

(54) MOUSE DEVICE WITH ULTRAVIOLET FOR DISINFECTION

(76) Inventor: Chi-Chai CHEN, Puzi City (TW)

Correspondence Address: Muncy, Geissler, Olds & Lowe, PLLC, 4000 Legato Road, Suite 310, FAIRFAX, VA, 22033, US

(21) Appl. No.: 12/617,499

(22) Filed: Nov. 12, 2009

(30) Foreign Application Priority Data
Nov. 25, 2008 (TW) 97221089

(51) Int. Cl. G06F 3/033

(52) U.S. Cl. 345/163; 250/492.1

(57) ABSTRACT

A mouse device with ultraviolet for disinfection is disclosed. The mouse device with ultraviolet for disinfection comprises a mouse device, a light directing layer disposed on an outer surface of the mouse device, and at least one lighting object disposed on the light directing layer and emitting ultraviolet rays outwardly by utilizing a power source applied by the mouse device, wherein ultraviolet is directed by the light directing layer to spread on the outer surface of the mouse device uniformly, and then the disinfection effect is achieved. Besides, a photocatalyst layer is disposed above the light directing layer, whereby ultraviolet interacts with the light directing layer, so as to enhance the ability of disinfection and bacteriostasis.

### BACKGROUND OF THE INVENTION

1. Field of the Invention

The present invention relates to a mouse device, particularly to a mouse device with ultraviolet and photocatalyst for disinfection.

2. Description of the Related Art

Computers often have been used as working platforms for working and learning process, etc. After a user operates a mouse manually for a long time, the bacteria, which harms to human body, is propagated from the mouse. Thus, it is not very sanitary to use the mouse. Usually, the mouse is cleaned with alcohol or water. But this way is not very convenient and does not maintain hygiene of the mouse at any time.

In view of the problems and shortcomings of the prior art, the present invention provides a mouse device with ultraviolet for disinfection, so as to solve the afore-mentioned problems of the prior art.

### SUMMARY OF THE INVENTION

A primary objective of the present invention is to provide a mouse device with ultraviolet for disinfection, which directs ultraviolet emitted from a lighting object disposed on the mouse to spread by a light directing layer disposed on the mouse device, and then the disinfection effect is achieved.

To achieve the abovementioned objective, the present invention provides a mouse device with ultraviolet for disinfection, which comprises a mouse device, a light directing layer disposed on an outer surface of the mouse device, and at least one lighting object disposed on the light directing layer and emitting ultraviolet rays outwardly by utilizing a power source applied by the mouse device, wherein ultraviolet is directed by the light directing layer to spread on the outer surface of the mouse device uniformly, and then the disinfection effect is achieved. Besides, a photocatalyst layer is disposed above the light directing layer, whereby ultraviolet interacts with the light directing layer, so as to enhance the ability of disinfection and bacteriostasis.

Below, the embodiments are described in detail in cooperation with the drawings to make easily understood the characteristics, technical contents and accomplishments of the present invention.

### BRIEF DESCRIPTION OF THE DRAWINGS

FIG. 1 is a perspective view schematically showing a mouse device according to a first embodiment of the present invention;

FIG. 2 is a sectional view schematically showing a mouse device according to a first embodiment of the present invention;

FIG. 3 is a perspective view schematically showing a mouse device according to a second embodiment of the present invention;

FIG. 4 is a perspective view schematically showing a mouse device according to a third embodiment of the present invention;

FIG. 5 is a perspective view schematically showing a mouse device according to a fourth embodiment of the present invention;

FIG. 6 is a sectional view schematically showing a mouse device according to a fourth embodiment of the present invention; and

FIG. 7 is a perspective view schematically showing a mouse device according to a fifth embodiment of the present invention;

### DETAILED DESCRIPTION OF THE INVENTION

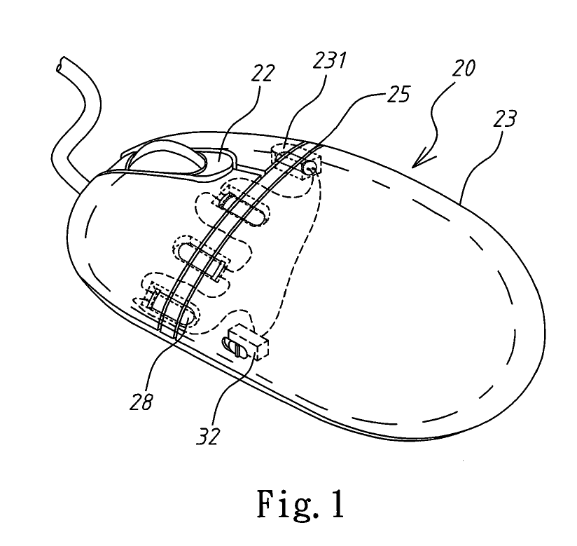

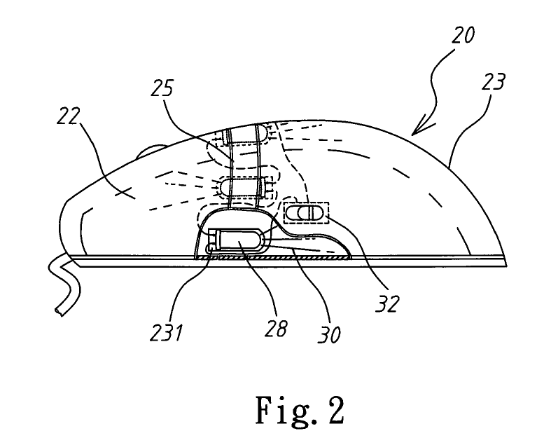

Refer to FIG. 1 and FIG. 2 in order to describe the present invention in detail. The present invention provides a mouse device with ultraviolet for disinfection 20, which comprises a mouse device 22 having a basic mouse structure seen in the market generally. A housing of the mouse device 22 is the plastic housing having all kinds of color or drawings. A light directing layer 23 is disposed on an outer surface of the mouse device 22. The thickness of the light directing layer 23 is from 0.1 cm to 0.8 cm approximately and the material of the light directing layer 23 is selected from acrylic or unleaded glass. Besides, the light directing layer 23 has at least one groove 231, which surrounds the waist of said light directing layer 23, and which is inserted with at least one lighting object.

The present invention is exemplified by a plurality of lighting objects. The lighting object of the embodiment is LED light bulb 28, which are arranged the waist of the light directing layer 23 along the grooves 231. The LED light bulb 28 can emit ultraviolet 30 outwardly by utilizing a power source applied by the mouse device 22, wherein ultraviolet is directed by the light directing layer 23 to spread on the outer surface of the mouse device 22. In the embodiment, the LED light bulb 28 is covered with a light-shield layer 25 disposed above the grooves 231, whereby ultraviolet emitted from the LED light bulb 28 is directed to spread toward the light directing layer 23 more easily. In other words, ultraviolet is spread on the outer surface of the housing 221 of the device mouse 22 uniformly, so as to achieve the ultraviolet disinfection effect with safety, environmental protection, none environmental pollution, and human body-nonjuring properties. Therefore, the number of the bacterium propagated on the outer surface of the mouse device 22 will be decreased, and the users will be protected from irritation reaction.

The grooves 231 are inserted with the light-shield layer 25, whose top and the top of the groove 231 are located at the same level. Thus, the light-shield layer 25 is formed a unity with the light directing layer 23, and towering feeling is not induced for appearance and using feel.

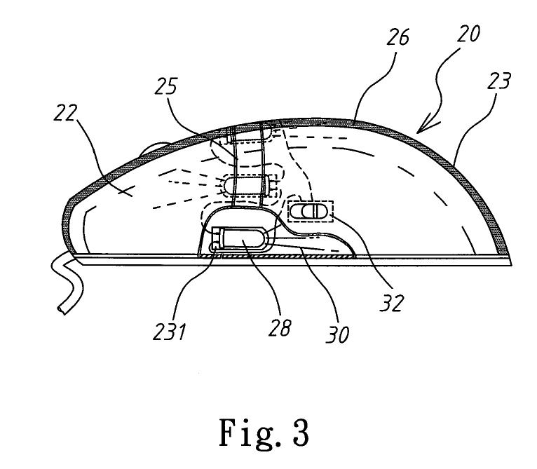

In addition, a switch 32, disposed on the outer surface of the mouse device 22, is coupled the LED light bulb 28. When the switch 32 is turned on and a user is using the mouse device 22, the LED light bulb 28 stops to emit ultraviolet outwardly, and the LED light bulb 28 does not emit ultraviolet outwardly to disinfect until the user does not use the mouse device 22. When the switch 32 is turned off, the LED light bulb 28 does not emit ultraviolet. The second embodiment of the present invention is shown in FIG. 3. The difference of the second embodiment and the preceding embodiment in that a photocatalyst layer 26 is disposed on the outer surface of the light directing layer 23. Photocatalyst is a catalyst, which is catalyzed by utilizing optical energy. Firstly, photocatalyst is coated or sprayed to form a thin film on the outer surface of the light directing layer 23. When the LED light bulb 28 emits ultraviolet 30 to disinfect, optical energy of the ultraviolet 30 activates the photocatalyst layer 26 to react oxidization or reduction with the bacterium attached to the outer surface of the mouse device 22, so as to achieve the purpose of disinfection and bacteriostasis.

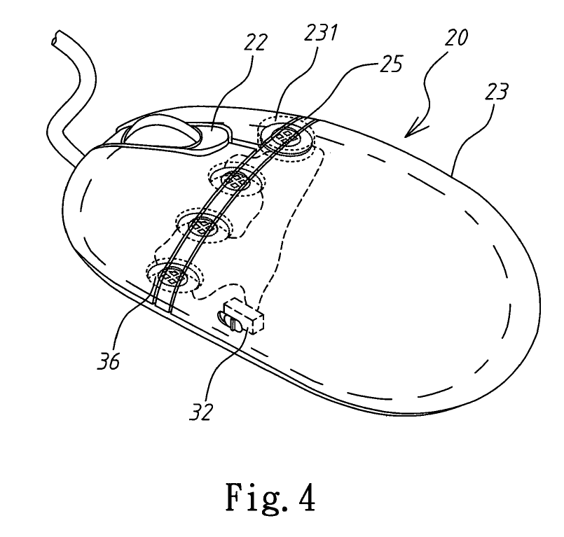

The third embodiment of the present invention is shown in FIG. 4. The difference of the third embodiment and the second embodiment in that the third embodiment has a plurality of fluorescent tubes 36 used as the lighting object.

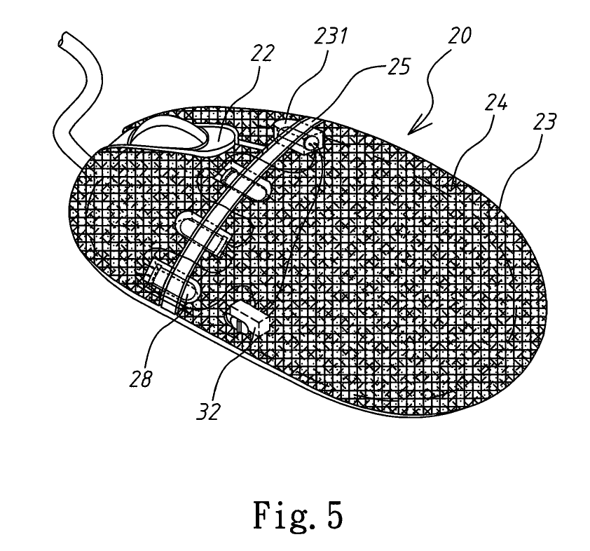

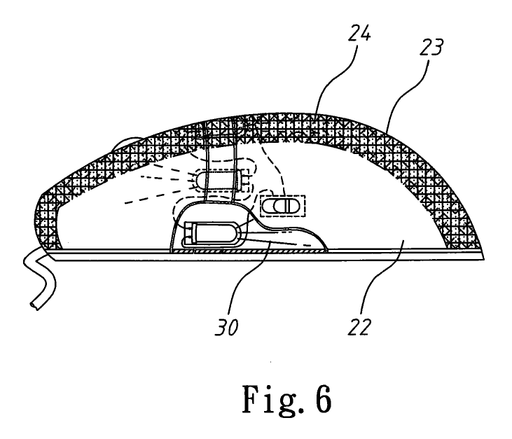

The fourth embodiment of the present invention is shown in FIG. 5 and FIG. 6. A prism member 24 is disposed on the inner surface of the light directing layer 23. When the ultraviolet 30 passes through the prism member 26, the ultraviolet 30 is refracted by the prism member 26, so as to help the ultraviolet 30 emitted from the LED light bulb 28 spread on the outer surface of the mouse device 22 uniformly.

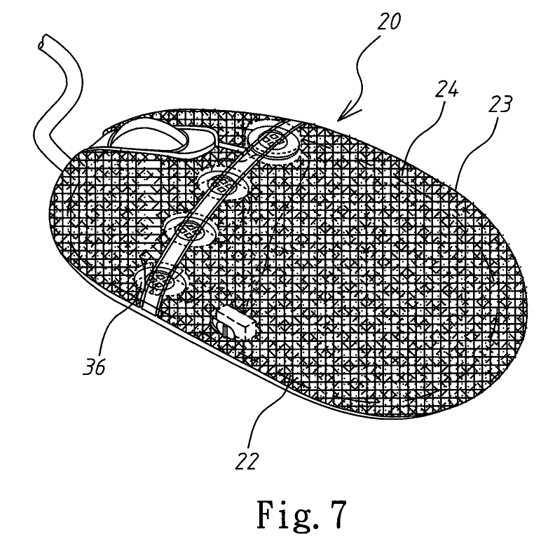

The fifth embodiment of the present invention is shown in FIG. 7. The difference of the fifth embodiment and the fourth embodiment in that the fifth embodiment has a plurality of fluorescent tubes 36 used as the lighting object.

The embodiments described above are only to exemplify the present invention but not to limit the scope of the present invention. Therefore, any equivalent modification or variation according to the shape, structures, characteristics and spirit disclosed in the present invention is to be also included within the scope of the present invention.

What is claimed is:

1. A mouse device with ultraviolet for disinfection comprising:
a mouse device;
a light directing layer disposed on an outer surface of said mouse device; and
at least one lighting object disposed on said light directing layer and emitting ultraviolet outwardly by utilizing a power source applied by said mouse device, wherein ultraviolet is directed by said light directing layer to spread on said outer surface of said mouse device, and then a disinfection effect is achieved.

2. The mouse device with ultraviolet for disinfection according to claim 1, wherein said lighting object is at least one LED light bulb or a fluorescent tube.

3. The mouse device with ultraviolet for disinfection according to claim 1, further comprising a switch disposed on said outer surface of said mouse device and coupled said lighting object, wherein when said switch is turned on and a user is using said mouse device, said lighting object stops to emit ultraviolet outwardly, and said lighting object does not emit ultraviolet outwardly until said user does not use said mouse device, and wherein when said switch is turned off, said lighting object does not emit ultraviolet.

4. The mouse device with ultraviolet for disinfection according to claim 1, further comprising a prism member disposed on an inner surface of said light directing layer.

5. The mouse device with ultraviolet for disinfection according to claim 1, further comprising a photocatalyst layer disposed on an outer surface of said light directing layer.

6. The mouse device with ultraviolet for disinfection according to claim 1, wherein said light directing layer has at least one groove, which is used to install said lighting object.

7. The mouse device with ultraviolet for disinfection according to claim 6, wherein said groove surrounds a waist of said light directing layer.

8. The mouse device with ultraviolet for disinfection according to claim 7, wherein said at least one lighting object is a plurality of lighting objects, which are arranged along said groove.

9. The mouse device with ultraviolet for disinfection according to claim 6, further comprising a light-shield layer disposed above said groove and covering said lighting object, whereby ultraviolet emitted from said lighting object is directed to spread toward said light directing layer more easily.

10. The mouse device with ultraviolet for disinfection according to claim 1, wherein said light directing layer comprises acrylic or unleaded glass.

11. The mouse device with ultraviolet for disinfection according to claim 1, wherein said light directing layer has a thickness of between 0.1 and 0.8 cm.
